(19) United States
(12) Patent Application Publication
(10) Pub. No.: US 2018/0272676 A1
(43) Pub. Date: Sep. 27, 2018

(54) STRETCH FILM INCORPORATING A SLIP SKIN LAYER

(71) Applicant: Paragon Films, Inc., Broken Arrow, TX (US)

(72) Inventors: Shaun Pirtle, Coweta, OK (US); Tom Roudebush, Broken Arrow, OK (US); Mike Hildreth, Broken Arrow, OK (US); George Eichbauer, Broken Arrow, OK (US)

(73) Assignee: Paragon Films, Inc., Broken Arrow, OK (US)

(21) Appl. No.: 15/934,451

(22) Filed: Mar. 23, 2018

Related U.S. Application Data
(60) Provisional application No. 62/475,522, filed on Mar. 23, 2017.

(51) Int. Cl. B32B 27/30; B32B 27/28; C08J 3/22; C08L 23/06; C08L 23/12; C08L 83/04; C08F 10/02; C08F 10/06

(52) U.S. Cl. CPC B32B 27/30; B32B 27/283; C08J 3/22; C08L 23/06; C08L 23/12; C08L 83/04; C08L 2207/14; C08F 10/06; C08L 2203/16; C08F 2500/21; C08L 2205/03; B32B 2307/744; C08L 2207/04; C08F 10/02

(57) ABSTRACT

A stretch film incorporating a cling layer and a slip skin layer is provided, the cling layer comprising a 25% to 75% ethylene-based elastomer blend in a metallocene linear low density polyethylene and the slip skin layer comprising an ultra-high molecular weight polysiloxane polymer of between 5% and 10% by weight.

### TECHNICAL FIELD

The present invention relates generally to compositions and methods for producing a stretch film incorporating a slip skin layer, and in a particular though non-limiting embodiment, to a stretch film comprising a slip skin layer having a variable and scalable coefficient of friction.

### BACKGROUND

A variety of bundling and packaging applications use stretch films. For example, machine and hand stretch films routinely secure bulky loads such as boxes, merchandise, produce, equipment, parts and other similar items on pallets.

Loads and pallets wrapped with stretch film often stand next to one another on trucks, trains, ships and the like, for storage, loading and transportation. Consequently, the outermost layer of stretch film encasing such loads and pallets physically contacts that of nearby loads and pallets. The contact results in pallet-to-pallet distortion and product damage during loading and transit.

There is, therefore, a longstanding but currently unmet need for stretch films providing adequate wrapping integrity, ease when unwinding from the film roll, and a slip performance coefficient of friction in measurable range.

### SUMMARY

A stretch film including a cling layer and a slip skin layer, wherein the cling layer comprises an ethylene-based elastomer blend in a metallocene linear low density polyethylene, and the slip skin layer comprises an ultra-high molecular weight polysiloxane polymer. The slip skin layer comprises a low coefficient of friction and the cling layer contains a lesser amount of cling additive.

### BRIEF DESCRIPTION OF SEVERAL EXAMPLE EMBODIMENTS

The invention described herein comprises an improved stretch film incorporating a slip skin layer on one side of the stretch film. The slip skin layer significantly improves the stretch film's performance by reducing contact between wrapped materials; reducing pallet-to-pallet distortion and product damage; maintaining adequate wrapping integrity; and unwinding easily for application.

In one embodiment, the stretch film further comprises a low film-to-film and outside-to-outside coefficient of friction. In a specific though non-limiting embodiment, the stretch film further comprises a low unwinding noise. In another specific though non-limiting embodiment, the stretch film comprises a low unwinding force. In another specific though non-limiting embodiment, the stretch film further comprises a moderate cling. In another specific though non-limiting embodiment, the stretch film further comprises a non-migratory cling. In another specific though non-limiting embodiment, the stretch film comprises a non-migratory slip. In another specific though non-limiting embodiment, the stretch film comprises a high load holding force. In another specific though non-limiting embodiment, the stretch film comprises a high elongation. In another specific though non-limiting embodiment, the stretch film comprises a good clarity. In another specific though non-limiting embodiment, the stretch film is economical. In another specific though non-limiting embodiment, the stretch film is technically feasible to produce.

In a further embodiment, the stretch film incorporating a slip skin layer differs from known one-sided cling films by eliminating, alleviating and minimizing pallet-to-pallet distortion and product damage caused by mechanical communication, abrasion, distortion and blocking during transport and storage. In yet another embodiment, the stretch film further enables undersize pallet use as an additional measure to prevent product damage, thereby reducing costs. Therefore, the stretch film protects products in virtually any wrapping operation.

In one example embodiment, the stretch film comprises a slip skin layer with a low coefficient of friction and provides a good clarity, a moderate cling, a low unwinding noise and a low unwinding force.

In another embodiment, the coefficient of friction of the slip skin layer is less than or equal to 1. In another embodiment, the coefficient of friction of the slip skin layer is less than or equal to 0.8. In yet another embodiment, the coefficient of friction of the slip skin layer is less than or equal to 0.6; and in a further embodiment still the coefficient of friction of the slip skin layer is less than or equal to 0.4.

In another embodiment, the slip skin layer comprises an ultra-high molecular weight polysiloxane polymer. In a further embodiment, the slip skin layer comprises a dosed 25% loaded masterbatch. In a further embodiment, the slip skin layer comprises a dosed 50% loaded masterbatch. In yet another embodiment, the slip skin layer comprises a dosed 25% loaded masterbatch further comprising an ultra-high molecular weight polysiloxane reacted with a polypropylene polymer.

In yet another embodiment, the slip skin layer comprises a non-migratory urethane. Ordinarily skilled artisans will readily appreciate that further embodiments of the slip skin layer comprise a plurality of other non-migratory additives.

In another embodiment, the slip skin layer further comprises a polyolefin resin, including at least a polyethylene resin, polypropylene resin and combinations thereof. According to other embodiments, the slip skin layer further comprises random co-polymer polypropylene. Ordinarily skilled artisans will readily appreciate that further embodiments of the slip skin layer will comprise, for example, a plurality of resins.

In another embodiment, the cling layer comprises a lesser amount of cling additive. In one example embodiment, the cling layer comprises at least one of an ethylene resin and propylene resin. According to still other embodiments, the cling layer comprises an ethylene-based elastomer blend, e.g., between about 25% and about 75% by weight in a metallocene linear low density polyethylene. In a further embodiment, the cling layer comprises an m-polypropylene elastomer resin. Ordinarily skilled artisans will readily appreciate further embodiments of the slip skin layer comprising a wide variety of additives combined with a plurality of polyolefin resins are inherently disclosed herein.

In another embodiment, the stretch film comprises a plurality of layers. In a further embodiment, the stretch film comprises a plurality of slip skin layers with additional internal layers, e.g., selected to correspond to the film properties desired by the end user. In one specific though non-limiting embodiment, the film comprises between about 2 and about 5 layers, though ordinarily skilled artisans will readily appreciate a plurality of layers are contemplated herein.

In a still further embodiment, the film comprises a great many additional layers, e.g., as many as 50 layers. In these examples, the skin layer comprises between about 4% and about 20% of the total thickness of the film and the internal layers comprise between about 60% and about 92% of the total film thickness.

According to other embodiments still, the total thickness of the film is greater than 25 microns. In a particular though non-limiting embodiment, the total thickness ranges from about 8 microns to about 50 microns. In another particular though non-limiting embodiment, the total thickness of the film is less than about 13 microns. In another particular though non-limiting embodiment, the film thickness is about 10 micron.

According to one example embodiment, the slip layer is incorporated into machine film. In other embodiments, the slip layer is incorporated into hand film or other types of stretch film. In still further embodiments, the slip layer is used in high elongation or high loading force film structures.

In yet another embodiment, the stretch film wraps a load such that the slip skin layer is the outer layer of the film. Thus, when two loads wrapped with the film communicate, the contact is minimized, thereby decreasing the amount of pallet-to-pallet distortion and product degradation.

According to certain embodiments, the slip skin layer maintains slip functionality over a stretch range from between about 0% to about 350%.

In a still further embodiment, undersized pallets are utilized to prevent product damage. For example, in some embodiments, smaller or more uniform pallets will result in cost savings.

A great many other advantages and variations of the instant disclosure will readily occur to ordinarily skilled artisans, even if significant departures from the non-limiting disclosure of structures and operations described herein are practiced.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A stretch film, said stretch film comprising:
a cling layer; and
a slip skin layer,
wherein the cling layer further comprises a 25% to 75% ethylene-based elastomer blend in a metallocene linear low density polyethylene, and
said slip skin layer further comprises an ultra-high molecular weight polysiloxane polymer of between 5% and 10% by weight.

2. The stretch film of claim 1, further comprising a polypropylene-based elastomer blend.

3. The stretch film of claim 2, wherein said elastomer blend further comprises at least one of an ethylene-based elastomer blend and a polypropylene-based elastomer blend.

4. The stretch film of claim 1, wherein the slip skin layer comprises a coefficient of friction less than or equal to 1.

5. The stretch film of claim 1, wherein the slip skin layer comprises a coefficient of friction less than or equal to 0.8.

6. The stretch film of claim 1, wherein the slip skin layer comprises a coefficient of friction less than or equal to 0.6.

7. The stretch film of claim 1, wherein the slip skin layer comprises a coefficient of friction less than or equal to 0.4.

8. The stretch film of claim 1, wherein the slip skin layer comprises an ultra-high molecular weight polysiloxane polymer.

9. The stretch film of claim 1, wherein the slip skin layer further comprises a dosed 10% to 25% loaded masterbatch.

10. The stretch film of claim 1, wherein the slip skin layer further comprises a dosed 5% to 50% loaded masterbatch.

11. The stretch film of claim 1, wherein the slip skin layer comprises a dosed 10% of a 25% loaded masterbatch further comprising an ultra-high molecular weight polysiloxane polymer reacted with a polypropylene polymer.

12. The stretch film of claim 1, wherein the slip skin layer comprises a non-migratory urethane.

13. The stretch film of claim 1, wherein the slip skin layer comprises a polyolefin resin, further comprising at least one polyethylene resin, polypropylene resin and combinations thereof.

14. The stretch film of claim 2, wherein the slip skin layer further comprises a random co-polymer polypropylene.

15. The stretch film of claim 1, wherein the cling layer comprises a lesser amount of cling additive.

16. The stretch film of claim 2, wherein the cling layer comprises a m-polypropylene elastomer resin.

17. The stretch film of claim 1, wherein the stretch film comprises a plurality of slip skin layers disposed in communication with additional internal layers.

18. The stretch film of claim 1, wherein each skin layer comprises between about 4% and about 20% of the total thickness of the film, and the internal layers comprise between about 60% and about 92% of the total film thickness.

19. The stretch film of claim 1, wherein the total thickness of the film is greater than 25 microns.

20. The stretch film of claim 1, wherein the total thickness of the film ranges from between about 8 microns and about 50 microns.

21. The stretch film of claim 1, wherein the total thickness of the film is less than about 13 microns.

22. The stretch film of claim 1, wherein the film thickness is about 10 microns.

23. The stretch film of claim 1, wherein the slip skin layer maintains stretch functionality over a stretch range from between about 0% and about 350%.
